(19) United States
(12) Patent Application Publication
(10) Pub. No.: US 2009/0230867 A1
(43) Pub. Date: Sep. 17, 2009

(54) Mercury-free metal halide high-pressure discharge lamp

(75) Inventors: Yasuhiko Wakahata, Kirchseeon (DE); Heinz-Juergen Wesseling, Pfaffing (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: BLV Licht- und Vakuumtechnik GmbH, Steinhoering (DE)

(21) Appl. No.: 12/401,235

(22) Filed: Mar. 10, 2009

(30) Foreign Application Priority Data
Mar. 11, 2008 (DE) 10 2008 013 607.7

(51) Int. Cl. H01J 61/12

(52) U.S. Cl. 313/637

(57) ABSTRACT

A mercury-free metal halide high pressure discharge lamp having a transparent and gastight sealed discharge vessel and two electrodes which protrude into the discharge vessel and are arranged in the discharge vessel opposite one another, with the discharge vessel being filled with a lamp filling which has: at least one noble gas, at least the elements of iron and zinc, as well as at least one halide, with the halide comprising bromide, and with the percentage of the bromide being at least 14 mole percent of the total halogen quantity and the following relationship applying to the ratio of molar density of zinc D in μmol/cm³ and electric field strength E in V/cm between the electrodes: 0.005≦D/E≦0.200.

### BACKGROUND OF THE INVENTION

1. Field of Invention

The invention relates to a high pressure discharge lamp and especially to a mercury-free metal halide high pressure discharge lamp. The invention further relates to an apparatus for generating ultraviolet radiation, comprising a mercury-free metal halide high pressure discharge lamp. Such a mercury-free metal halide high pressure discharge lamp can especially be used in photochemical process systems, e.g., for curing lacquers, for disinfection and/or for tanning purposes.

2. Description of Related Art

High pressure discharge lamps are gas-discharge lamps. In conventional high pressure discharge lamps, either mercury alone or, as in the case of modern metal halide high pressure discharge lamps, mercury in combination with traces of metal halides is disposed under higher pressure in addition to a noble gas in a gastight sealed discharge vessel. Electrodes protrude into the discharge vessel, between which a self-maintaining gas discharge (an arc) is formed in the case of a sufficiently high electric potential difference. High pressure discharge lamps usually emit a line spectrum, which means lines are emitted in wavelengths which are characteristic for the mercury and for the admixtures. The mercury spectrum alone has large gaps, especially in the UV-A range, which are only filled by admixtures. In addition to UV-A, high pressure discharge lamps emit considerable amounts of UV-B, UV-C, visible light and infrared. Applications for high pressure discharge lamps are found in the area of industrial and street lighting, in the lighting of shop windows, lighting of stadiums, architecture and beamers. Moreover, high pressure discharge lamps are used in photochemical processes, e.g., for curing lacquer or for disinfection. Further areas of application are tanning lamps which are used especially in solariums.

The filling of high pressure discharge lamps comprises, on the one hand, a discharge gas (generally a metal halide such as sodium iodide or scandium iodide) which represents the material (light generator) which emits the actual light, and, on the other hand, mercury which is primarily used for voltage gradient formation and essentially has the function of increasing efficiency and burning voltage of the high pressure discharge lamp.

High pressure discharge lamps of the kind mentioned above are widely in use as a result of their favorable color properties. The disadvantageous aspect is however that they contain mercury. Mercury-containing high pressure discharge lamps must be disposed of in an environmentally safe way in order to isolate the mercury contained in the same. Also, broken lamps represent a hazard in the respect that mercury can be released into the breathable air and can cause health impairments. Moreover, escaping mercury can attack aluminum under formation of amalgam, which may lead to the structural weakening of airplane fuselages and has led for this reason to strict transport requirements for mercury-containing materials. It is a further disadvantage of mercury-containing tanning lamps that they have a relatively high percentage of radiation in the UV-B range, which has a carcinogenic effect.

For these reasons it is desirable to provide a mercury-free high pressure discharge lamp. It is not possible however to omit the share of mercury in the known types of lamps without taking additional measures. A general problem in mercury-free high pressure discharge lamps is that a lower burning voltage and thus a higher lamp current and thus a lower efficiency is obtained at the same power of the lamp in permanent operation.

A mercury-free metal halide discharge lamp is known from International Patent Application Publication WO-A-99/05699. Xenon as a buffer gas and an ionizable filling are used, which filling contains at least sodium iodide and zinc. However, certain requirements must be placed on the geometry of the discharge vessel and the used electrodes for a satisfactory operation of the metal halide discharge lamp. According to International Patent Application Publication WO-A-99/05699, the electrode gap EA and the inside diameter Di of the discharge vessel must meet the relation 1≦EA/Di≦4. This represents a far from inconsiderable limitation on the possible geometry of the used discharge vessels. In particular, not every long-arc lamp meets these geometrical requirements.

According to Japanese Patent Application JP 09293482 A, which discloses a metal-vapor discharge lamp, requirements are also placed on the geometrical dimensions of the discharge vessel. The focus of this publication is on a favorable energy conversion efficiency in the range of 200 and 250 nm, which means in the UV-C range.

A high pressure discharge lamp is known from International Patent Application Publication WO 2005/112074 A2 which is free of mercury. The used ionizable filling of the discharge vessel consists of xenon with a cold filling pressure of 11,800 hPa, 0.25 mg of sodium iodide, 0.18 mg of scandium iodide, 0.03 mg of zinc iodide and 0.0024 mg of indium iodide. In a high pressure discharge lamp which is filled in this manner, the problem of the comparatively higher lamp current occurs (as compared to mercury-containing lamps). The electrodes which protrude into the discharge vessel are sealed by means of embedded molybdenum foils, and this molybdenum foil region which is connected with the electrode is subjected to a high thermal load during lamp operation. This can lead to a lifting of the molybdenum foil from the quartz glass of the discharge vessel and to cracks in the glass and thus to a premature failure of the lamp. In order to solve this problem it is proposed by International Patent Application Publication WO 2005/112074 A2 to set at more than 5 mm the minimum distance of the respective molybdenum foil from the end of the electrode which is connected to the same and protrudes into the interior space of the discharge vessel. This reduces the thermal load of the molybdenum foil only partly, however.

### SUMMARY OF THE INVENTION

The present invention is intended to overcome the disadvantages of the known high pressure discharge lamps of the state of the art. In particular, it is the object of the present invention to provide an alternative mercury-free high pressure discharge lamp on the basis of metal halide which has an especially high intensity in the UV-A range, can be realized with a large variety of lamp geometries and, in comparison with mercury-containing lamps, does not require any higher or only a marginally higher lamp current.

In particular, the high pressure discharge lamp in accordance with the invention shall achieve at least 63% of the intensity of a comparable mercury-containing lamp. This value is explained as follows. Typically, mercury-containing lamps are produced with batch variations of 10% and are operated for economic reasons up to a further drop in intensity to 70%, so that usually an exchange occurs at 63% of the initial nominal value.

The object of the invention is achieved as described below.

A first aspect of the invention relates to a mercury-free metal halide high pressure discharge lamp with a transparent and gastight sealed discharge vessel and two electrodes which protrude into the discharge vessel and are arranged opposite of one another in the discharge vessel. The discharge vessel is filled with a lamp filling which comprises at least one noble gas, at least the elements of iron and zinc and at least one halide, with the halide comprising bromide. The percentage of the bromide is at least 14 mole percent of the total halide quantity. The relation 0.005≦D/E≦0.200 applies to the ratio of molar density of the zinc D in μmol/cm³ and electric field strength E between the electrodes in V/cm.

The discharge lamp in accordance with the invention principally corresponds in respect to its external shape to the discharge lamps conventionally found under the state of the art, but they differ from the same in respect of the composition of the lamp filling. The invention is based on the finding that, through a special selection of the filling substances on the one hand (with the mandatory components of noble gas, iron, zinc and halide, which necessarily includes bromide), and the quantitative adjustment thereof, on the other hand (percentage of bromide in relation to total quantity of halide and share of zinc), a mercury-free lamp with high radiated power in the UV-A range with simultaneously comparatively low power consumption can be obtained, which lamp can be realized with a large variety of shapes and sizes of the bulb.

It was recognized within the scope of the invention that maintaining a specific molar density of the zinc, i.e., the molar zinc quantity (in μmol) with reference to the volume (in cm³) of the discharge space of the lamp bulb, in relation to the electric field strength (in V/cm), the quotient of burning voltage (in V) and the distance between the electrodes (in cm) has relevant importance in achieving the desired radiation efficiency. Accordingly, the ratio of molar density of the zinc D in μmol/cm³ and electric field strength E in V/cm is set between the electrodes according to the relation 0.005≦D/E≦0.200. When this range is maintained, a discharge lamp is obtained, substantially irrespective of its outside shape, whose irradiance is at least 63% of a comparable mercury-containing lamp. Preferably, the quotient of D/E is in the range of 0.01 to 0.18. An irradiance of 73% or more with respect to a comparable mercury-containing lamp can usually be realized when the ratio of D/E is in the range of 0.025 to 0.165. Notice must further be taken in respect of the relation of D/E that it is substantially independent of the type of supply of current to the electrodes and the used ballast. The reason for this is that the field strength is a lamp property which practically does not depend on power or power supply.

Zinc acts as a voltage-increasing filling substance. It prevents a voltage drop between the electrodes and thus increases residual voltage available for generating radiation. Zinc is preferably filled in form of a zinc halide, especially zinc bromide and/or zinc iodide. It is not preferable however to use the element of zinc in form of metallic zinc. In comparison with the element of iron which is also present in the lamp filling, the zinc is the base metal. Metallic zinc could therefore react with iron halide into zinc halide and metallic iron. This iron would precipitate as a solid on the wall of the discharge vessel, and thus, no longer be available as a radiation-active substance, on the one hand, and lead to a blackening of the bulb, on the other hand. Both would reduce the radiation yield.

The stated quantities in accordance with the invention relate to a state of the lamp filling in which its components are virtually completely evaporated and have been brought to the gas phase. Specifically, at least 70 percent by weight, especially at least 80 percent by weight, of the lamp filling are present in the gaseous state. The stated quantities relate especially to a lamp filling that has been brought completely to the gas phase.

A further relevant aspect of the invention is the percentage of bromide in the lamp filling. In accordance with the invention, it is at least 14 molar percent of the total quantity of halogen. The halogen can either completely consist of bromide or of a mixture of halides. Preferably, in the case of a halide mixture, a further halide is present, especially an iodide. The halide is used in the known manner to secure the halogen cycle, facilitates the evaporation of the metallic components of the lamp filling and counters a blackening of the lamp bulb. The halide is filled into the discharge space in combined form, i.e., in the form of a metal halide.

A further important component of the lamp filling of the discharge lamp in accordance with the invention is iron. Iron can be filled into the discharge space as metallic iron and/or in form of an iron halide, especially in form of iron iodide. The quantity of the iron preferably lies between 0.1 and 2.5 μmol Fe/cm³ of the inside volume of the discharge space, especially between 0.25 and 2 μmol/cm³. A relevant increase in the spectrally integrated UV-A radiation in the wavelength range of 315 nm to 400 nm is achieved by adding iron. The 365 nm emission line of mercury in mercury-containing metal halide high pressure discharge lamps can be replaced in this manner. The increase in the spectrally integrated UV-A radiation can be up to a factor of 2.5 in comparison with an identically constructed mercury-containing high pressure discharge lamp.

Finally, at least one noble gas is present in the discharge lamp in accordance with the invention as a mandatory component of the lamp filling. In principle, the noble gas can be any known noble gas. Preferably, xenon and/or argon and especially xenon alone are used. The noble gas is used primarily to improve the starting properties of the discharge lamp. The pressure of the noble gas lies appropriately in a range of a few hPa up to several hundred hPa, e.g., between 10 and 600 hPa, preferably between 50 hPa and 400 hPa.

In addition to the components as mentioned above, the lamp filling can contain further components, especially further metallic elements. They are used primarily for filling the line spectrum in order to obtain the desired spectral distribution. For example, the lamp filling can contain at least one of the elements of thallium, cobalt, tin, palladium, ruthenium and silver. These metals are also added preferably in form of their halides, with bromide and/or iodide being preferable again. A preferred lamp filling contains zinc bromide, iron iodide and thallium iodide, for example. In addition, zinc iodide can also be added. Sodium halides and especially sodium iodide are preferably omitted however in order to avoid the undesirable intensive spectral lines of this metal.

As already mentioned, the invention is suitable for application in a plurality of differently arranged lamp bulbs. Lamp geometry and size have an only minor influence on the achieved radiated power. In this respect, no special requirements are placed on the dimensions of the discharge vessel, as is the case for example in International Patent Application Publication WO-A-99/05699 or Japanese Patent Application JP 0929348 A. The high pressure discharge lamp can be a short-arc lamp or a long-arc lamp. As a result, the discharge vessel can be substantially spherical, oval or even of an elongated cylindrical shape. Quartz glass, as conventionally used in the state of the art, is appropriately used for the lamp bulb. The gas-tight sealing is preferably achieved by means of pinch sealing, with molybdenum foils preferably being used for connecting the electrodes. The electrodes are principally also arranged as in the state of the art. It is not mandatory that the electrodes are arranged in a symmetrical way in the discharge vessel or are constructed similarly.

The high pressure discharge lamp in accordance with the invention can be operated with any desired suitable ballast devices, with the ballast devices leading to different current and voltage loads at the same constant power load. The desired radiation efficiency of the mercury-free metal halide high pressure discharge lamp can be achieved independent of the respective operating mode of the lamp. This can be explained in such a way that the share of the filling determining the radiation in the discharge vessel (which is at least metallic iron and/or at least one iron halide) remains the same during different operating modes.

The mercury-free metal halide high pressure discharge lamp in accordance with the invention is preferably used in an apparatus for generating ultraviolet radiation, especially in the UV-A range. The preferred use of the mercury-free metal halide high pressure discharge lamp is the one in photochemical process systems, e.g., for curing lacquer, for disinfection and/or for tanning purposes.

The invention is now explained below in further detail below with reference to the accompanying drawings which merely describe preferred embodiments to which the invention is not limited.

### BRIEF DESCRIPTION OF THE DRAWINGS

FIG. 1 is a schematic view of a high pressure discharge lamp with a first geometry;

FIG. 2 is a schematic view of a high pressure discharge lamp with a second geometry;

FIG. 3 is a schematic view of a high pressure discharge lamp with a third geometry;

FIG. 4 is a graph showing radiation intensity of the spectrum of a mercury-containing lamp of the state of the art;

FIG. 5 is a graph showing radiation intensity of the spectrum of a mercury-free lamp in accordance with the invention;

FIG. 6 is a graph comparing the spectrums of FIGS. 4 and 5;

FIG. 7 is a graph which represents the dependence of the integrated radiation intensity on the bromide percentage of the halogens used according to a first test series with a lamp geometry according to FIG. 1,

FIG. 8 is a graph which represents the dependence of the integrated intensity of radiation on the relation of zinc concentration to electric field strength; and

FIG. 9 is a table showing the characteristics of lamps of the first, second and third geometries and a conventional lamp used in comparative tests.

### DETAILED DESCRIPTION OF THE INVENTION

The described test series were performed by way of example and the following results achieved. In the various test series, mercury-free metal halide high pressure discharge lamps are provided with different fillings. The integrated intensity of radiation of the high pressure discharge lamp produced in this manner was compared with the integrated intensity of radiation of a mercury-containing lamp constructed in the same way. Thereafter, the geometry of the used lamps was varied in order to examine a possible influence of the lamp geometry on the integrated intensity. Furthermore, the lamps were operated under different operating modes in order to examine a possible influence of the different operating modes on a change in efficiency, i.e., the integrated intensity of radiation of the high pressure discharge lamp in accordance with the invention compared with a mercury-containing high pressure discharge lamp constructed in a similar way. Furthermore, the discharge lamps were operated with different ballast devices.

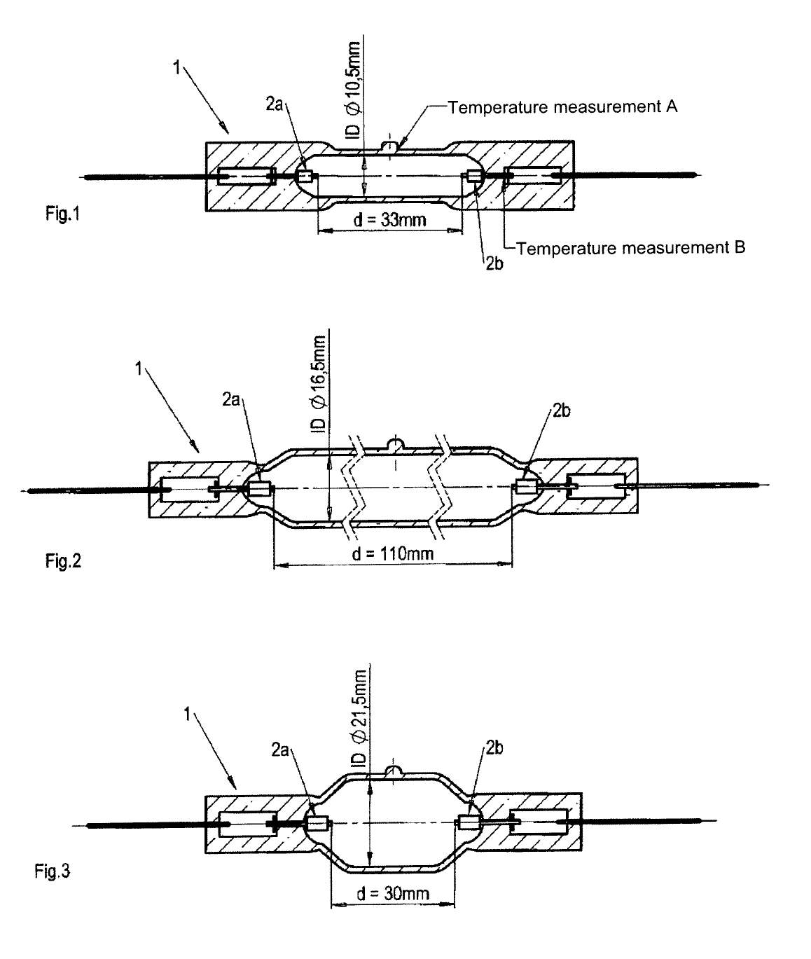

FIG. 1 shows a schematic view of a high pressure discharge lamp with a first geometry. It comprises a cylindrical discharge vessel 1, into which protrudes a pair of electrodes 2a, 2b. The two electrodes 2a, 2b lie opposite of each other at a distance d of 33 mm. The distance is measured from the tip of one electrode to the tip of the other electrode. An arc is formed between the electrodes at a respective potential difference. The inside diameter ID of the discharge vessel is 10.5 mm in the first geometry. The inside volume IV of the discharge vessel is 3.1 cm³.

FIG. 2 shows a schematic view of a high pressure discharge lamp with a second geometry. In comparison with the first geometry, the electrode gap d is greatly increased in the high pressure discharge lamp with the second geometry. It is now 110 mm. The inside diameter ID of the discharge vessel 1, however, was increased only slightly to 16.5 mm in the second geometry. The inside volume is 24 cm³.

FIG. 3 shows a schematic view of a high pressure discharge lamp with a third geometry. The electrode gap d between the electrodes 2a, 2b is 30 mm. The inside diameter ID of the discharge vessel is 21.5 mm, and the inside volume IV is 9.5 cm³.

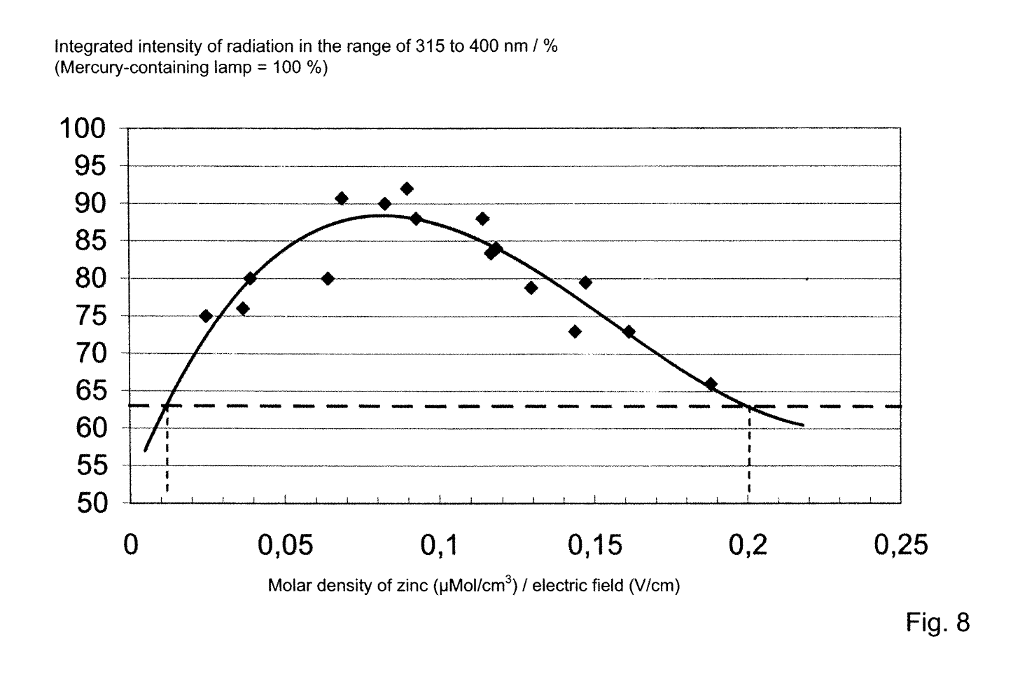

The high pressure discharge lamps with the geometries 1, 2 and 3 were provided with different lamp fillings. The integrated intensity of the lamps was measured in the range of 315 to 400 nm. A mercury-containing high pressure discharge lamp constructed similarly was used as a reference value, which means that the lamps shown in FIGS. 1, 2 and 3 were provided for comparison purposes with a mercury-containing filling and the integrated intensity of the mercury-containing lamp in the range of between 315 and 400 nm was determined for reference purposes. The respective examples are stated below and are summarized in FIG. 8:

### Comparative Example 1

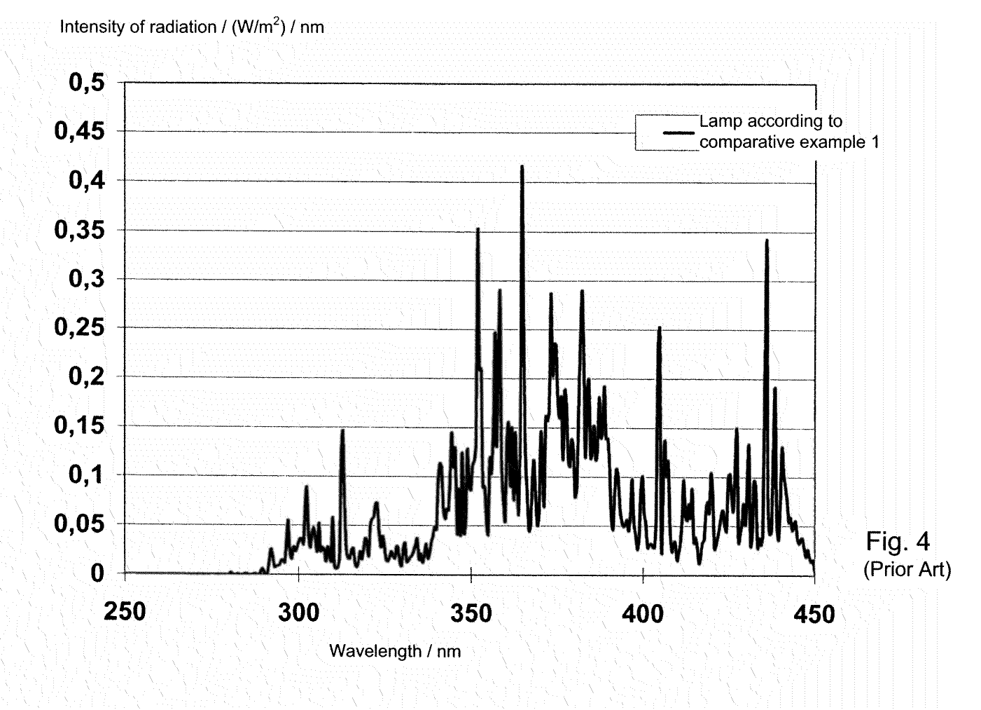

80 hPa of argon, 12 mg of mercury, 0.70 mg of iron iodide and 0.02 mg of thallium iodide were filled into a discharge vessel made of quartz glass according to the one of FIG. 1. The thus obtained mercury-containing discharge lamp was operated with a power of 400 W, a lamp voltage of 114 V, a lamp current of 3.5 A and a power factor of 0.99. The spectrum of the comparative lamp is shown in FIG. 4.

### Comparative Example 2

400 hPa of xenon, 3.0 mg of zinc iodide, 0.98 mg of iron iodide and 0.02 mg of thallium iodide were filled into a discharge vessel made of quartz glass according to the one of FIG. 1. The thus obtained mercury-free and bromide free discharge lamp was operated with a power of 400 W, a lamp voltage of 60 V, a lamp current of 6.73 A and a power factor of 0.99.

### Example 1

400 hPa of xenon, 2.0 mg of zinc iodide, 0.5 mg of zinc bromide, 0.95 mg of iron iodide and 0.02 mg of thallium iodide were filled into a discharge vessel made of quartz glass according to the one of FIG. 1. The thus obtained mercury-free discharge lamp in accordance with the invention was operated with a power of 400 W, a lamp voltage of 75 V, a lamp current of 5.35 A and a power factor of 0.99.

### Examples 2 to 10

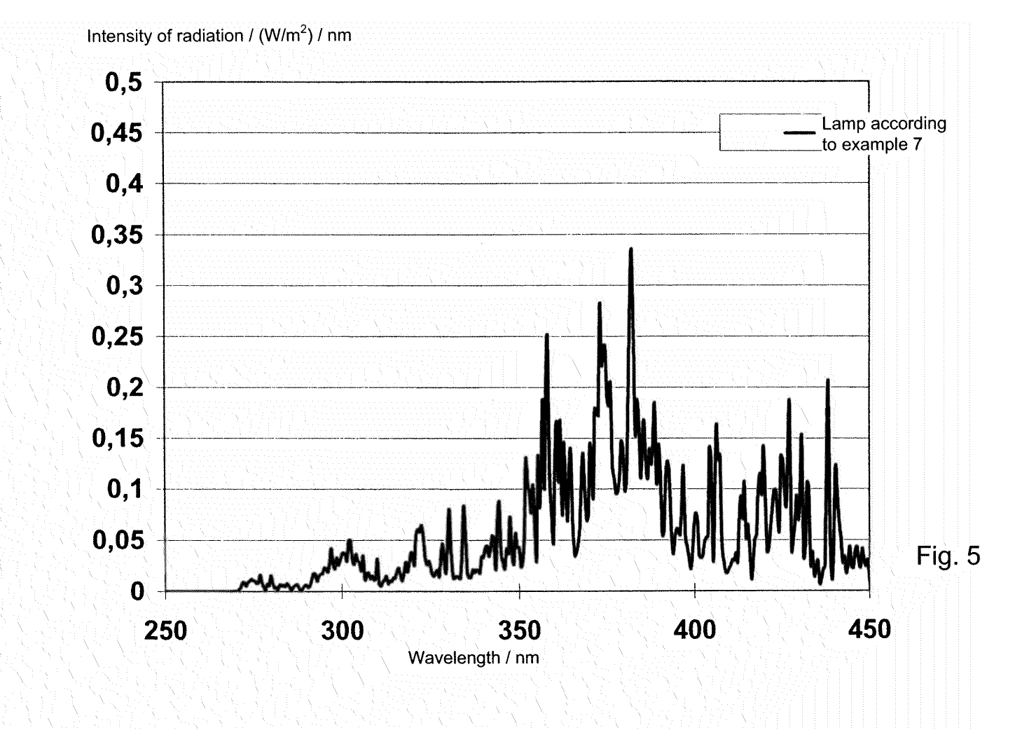

Further discharge lamps in accordance with the invention were produced based on example 1. The respective lamp filling is shown in FIG. 8. The power factor was 0.99 in each case. The spectrum is shown in FIG. 5 for the lamp according to example 7.

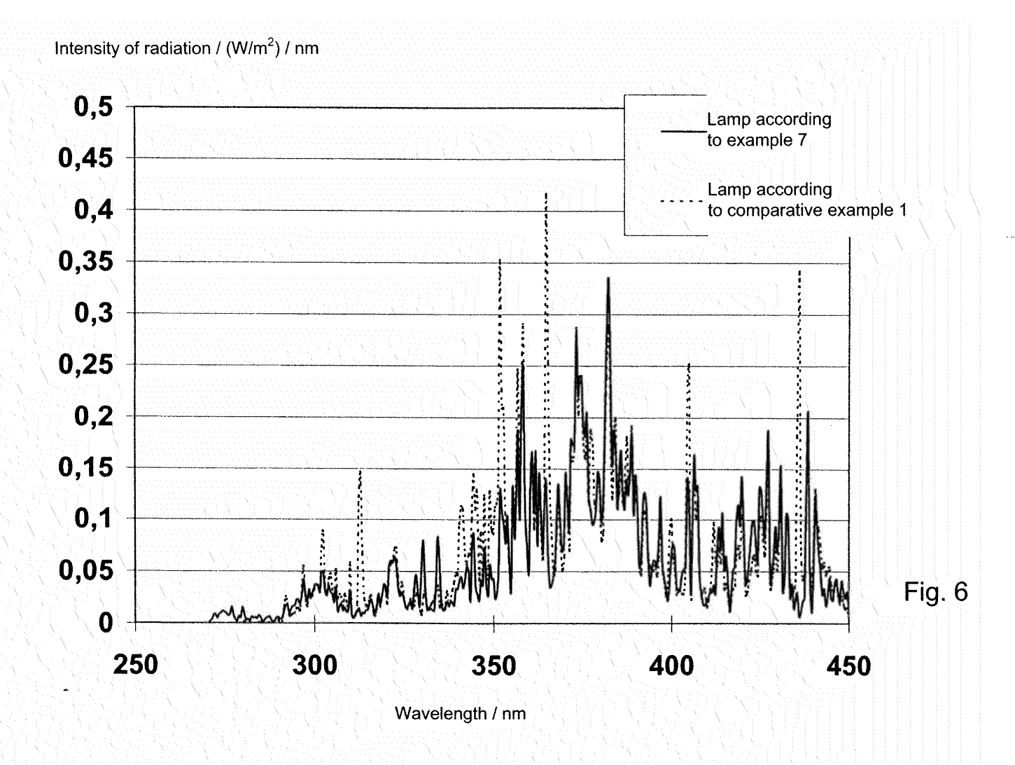

FIG. 6 shows a comparison of the mercury-containing lamp of comparative example 1 with the lamp of example 7 in accordance with the invention, such that the spectrums of the two lamps are shown in a superimposed way.

### Comparative Example 3

50 hPa of argon, 23 mg of mercury, 1.96 mg of iron iodide and 0.02 mg of thallium iodide were filled into a discharge vessel made of quartz glass according to the one of FIG. 2. The thus obtained mercury-containing and bromide-free discharge lamp was operated with a power of 1200 W, a lamp voltage of 140 V, a lamp current of 9 A and a power factor of 0.95. Such lamps are used for UV curing for example. Departing from the other examples, the intensity of radiation was measured at a distance of 130 cm from the lamp in this case and the following examples 11 to 13.

### Example 11

A discharge lamp in accordance with the invention which corresponds to comparative example 3 was produced by using the discharge vessel made of quartz glass as shown in FIG. 2, such that 50 hPa of xenon, 6.0 mg of zinc bromide, 1.96 mg of iron iodide and 0.24 mg of thallium iodide were filled into the vessel. The thus obtained mercury-free discharge lamp in accordance with the invention was operated with a power of 1200 W, a lamp voltage of 103 V, a lamp current of 12.3 A and a power factor of 0.95.

### Examples 12 and 13

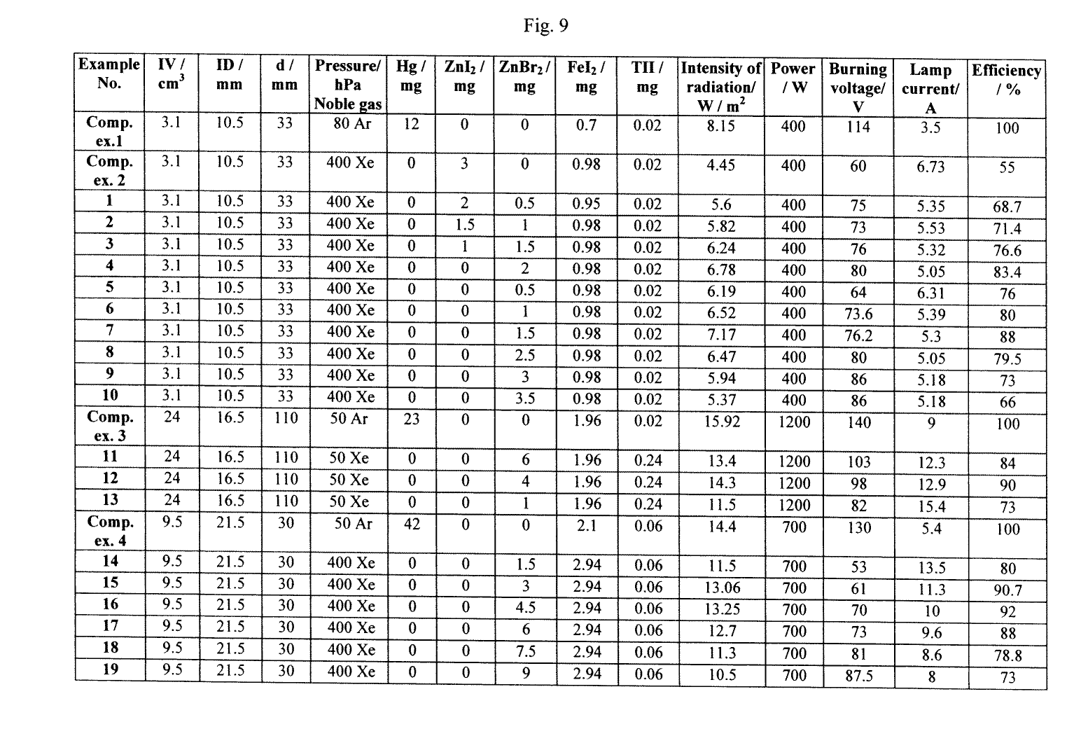

Based on example 11, further discharge lamps in accordance with the invention were produced. The respective lamp filling is shown in FIG. 9.

### Comparative Example 4

50 hPa of argon, 42 mg of mercury, 2.1 mg of iron iodide and 0.06 mg of thallium iodide were filled into a discharge vessel made of quartz glass according to the one of FIG. 3. The thus obtained mercury-containing and bromide-free discharge lamp was operated with a power of 700 W, a lamp voltage of 130 V, a lamp current of 5.4 A and a power factor of 0.95.

### Example 14

A discharge lamp in accordance with the invention which corresponds to comparative example 4 was produced from quartz glass by using the discharge vessel shown in FIG. 3, such that 400 hPa of xenon, 1.5 mg of zinc bromide, 2.94 mg of iron iodide and 0.06 mg of thallium iodide were filled in. The thus obtained mercury-free discharge lamp in accordance with the invention was operated with a power of 700 W, a lamp voltage of 53 V, a lamp current of 13.5 A and a power factor of 0.95.

### Examples 15 to 19

Based on example 14, further discharge lamps in accordance with the invention were produced. The respective lamp filling is shown in FIG. 9.

The radiation efficiency was determined for all discharge lamps listed in FIG. 9. It concerns the intensity of radiation (in (W/m²)/nm) of the respective lamp in the wavelength range of 315 to 400 nm, which is of interest here. Measurement was performed at a distance of 115 cm from the lamp. The intensity of radiation integrated over this wavelength range is each determined, i.e., the area beneath the spectrum in the wavelength range of 315 to 400 nm. The relative intensities of radiation are stated in the table. The integrated intensity of radiation of the mercury-containing comparative lamps of each group of lamps is set at 100%. The intensity of radiation of the other lamps of the group is stated as a fraction of the 100% intensity (cf. right column in FIG. 9; “efficiency”=relative integrated intensity of radiation).

The series of measurements performed show that the discharge vessel needs to contain at least iron, zinc, halide and bromide among the same in addition to noble gas in order to achieve an acceptable integrated intensity in the range of 315 to 400 nm at all. It was further found that further conditions must be imposed on the percentage of bromide and the ratio of molar density of zinc D and electric field strength E between the electrodes when the mercury-free metal halide high pressure discharge lamp is to achieve an efficiency of at least 63%. The percentage of the bromide must be at least 14 mole percent of the total quantity of halogen. The relationship 0.005≦D/E≦0.200 must apply to the ratio of molar density of the zinc D in μmol/cm³ and electric field strength E in volt/cm between the electrodes. In order to achieve greater efficiency, it is necessary to increase the percentage of bromide in the total halogen quantity and to limit further the range for the ratio of molar density of the zinc and the electric field strength E. Measurement was performed at saturation, in which at least approx. 70% of the lamp filling of the discharge vessel is present in a vaporous form.

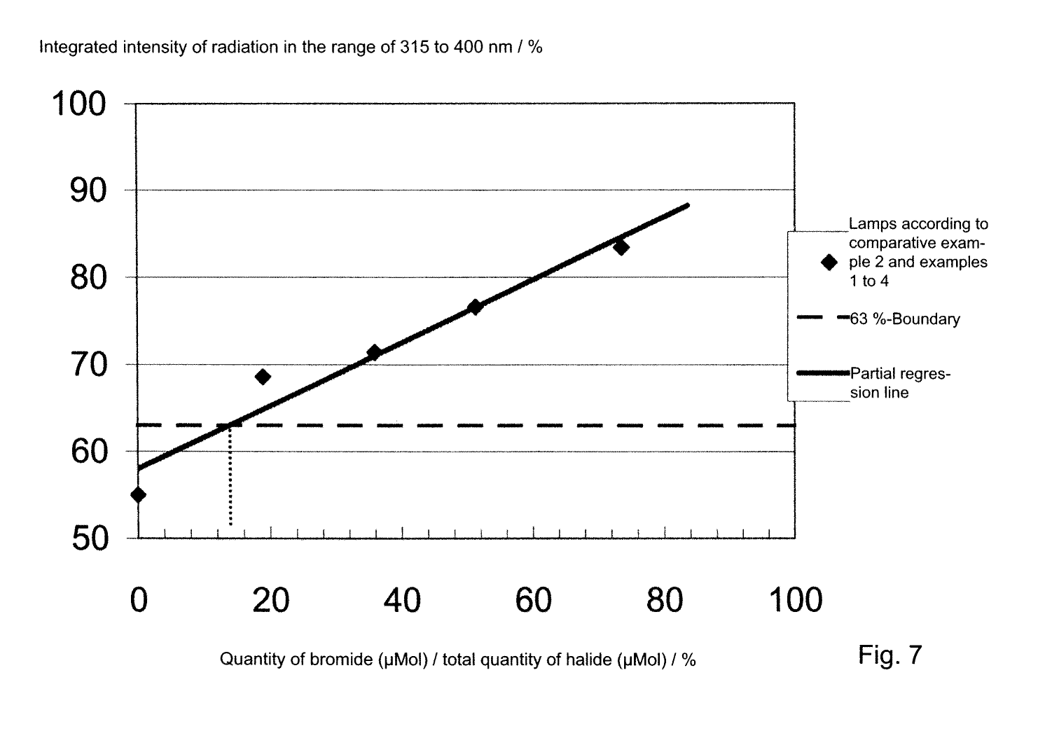

FIG. 7 shows a diagram which represents the dependence of the integrated intensity on the bromide percentage of the used halogens according to a first test series with a lamp geometry according to FIG. 1. This example shows an approximately linear connection between the percentage of bromide in the total halogen quantity and the integrated intensity in the wavelength range of interest between 315 nm and 400 nm. When a minimum efficiency of 63% is demanded, this leads to a minimum percentage of bromide from the ratio of the partial regression line with the 63% mark to a bromide quantity of at least 14 mole percent in the total halogen quantity.

FIG. 8 shows a diagram which shows the dependence of the integrated intensity on the ratio of zinc concentration to electric field strength. Measured values obtained with lamps of all three geometries were entered in the diagram. A compensating curve was placed between the measuring points. According to this compensating curve, there is at first a rise of the integrated intensity with rising ratio of zinc concentration to electric field. In the range of between 0.06 (μmol/cm³)/(volt/cm) and approximately 0.12 (μmol/cm³)/(volt/cm), a maximum integrated intensity of up to 92% was achieved. The curve gradually flattens again in the further progression. When an integrated intensity of at least 63% is demanded, the graphical illustration shows that the ratio of molar density of the zinc D in μmol/cm³ and electric field strength in volt/cm between the electrodes needs to fulfil the condition 0.005≦D/E≦0.200.

Further tests with the mercury-free metal halide high pressure discharge lamps in accordance with the invention were performed. The lamps were operated under normal operation and underload operation. A temperature measurement was performed for this purpose at points A and B, as shown in FIG. 1. At 350 W for example (example No. 7) close to the melting point of the iron halide of 680° C. up to 1050° C., only a slight minor change in efficiency from 87% to 75% was determined. The different operating modes hardly have an influence on the measured efficiency. This can be explained in such a way that the determining factor for the radiation is finally the iron or iron halide filling of the lamps. This remains unchanged in the various operating modes.

The discharge lamps were operated in further tests with a large variety of ballast devices, which led to different current and voltage loads at constant power load. For example, a lamp of the first geometry (example No. 4) was operated with a conventional inductivity (power factor 0.85) and with an electronic ballast with rectangular operation (power factor 0.99). In both cases, the same efficiency value of 85% was measured. The use of different ballast devices thus has no influence on the efficiency value to be expected. This can be explained substantially in such a way that the field strength concerns a lamp property which is hardly dependent on power or power supply.

It has been seen that it is certainly possible to provide a mercury-free metal halide high pressure discharge lamps which is capable of providing a minimum efficiency of 63% (in comparison with a mercury reference lamp). It is merely necessary to place certain requirements on the filling of the high pressure discharge lamp, but no further requirements need to be placed on the lamp geometry. It has further been achieved to provide a mercury-free metal halide high pressure discharge lamp which works without sodium iodide. The relevance of the percentage of bromide in the total halogen quantity for the efficiency of the lamp was recognized, and also the relevance of the ratio of molar density of zinc D and electric field strength E between the electrodes was recognized. The conditions were derived from these findings which are to be placed on a filling of the discharge vessel of the mercury-free metal halide high pressure discharge lamp in accordance with the invention.

The mercury-free metal halide high pressure discharge lamp in accordance with the invention can be used especially for photochemical process systems, especially for curing lacquer, for disinfection and/or for tanning purposes. An environmentally friendly and nevertheless efficient high pressure lamp can now be used in this and other fields of application.

1. A mercury-free metal halide high-pressure discharge lamp, comprising:
a transparent and gastight sealed discharge vessel and
two electrodes which protrude into the discharge vessel and are arranged in the discharge vessel opposite one another;
with the discharge vessel having a discharge space that is filled with a lamp filling which comprises:
at least one noble gas,
at least the elements of iron and zinc, as well as
at least one halide, with the halide comprising a bromide, and with
the percentage of the bromide being at least 14 mole percent of the total halogen quantity and the following relationship applying to the ratio of molar density of zinc D in μmol/cm³ and electric field strength E in V/cm between the electrodes: 0.005≦D/E≦0.200.

2. A mercury-free metal halide high-pressure discharge lamp according to claim 1, wherein the iron is in the form of at least one of metallic iron and at least one iron halide.

3. A mercury-free metal halide high-pressure discharge lamp according to claim 2, wherein the iron is filled in a quantity of 0.1 to 2.5 μmol/cm³ of an inside volume of the discharge space, especially from 0.25 to 2 μmol/cm³.

4. A mercury-free metal halide high-pressure discharge lamp according to claim 1, wherein the zinc is in the form of zinc halide, especially zinc bromide and/or zinc iodide.

5. A mercury-free metal halide high-pressure discharge lamp according to claim 1, wherein the lamp filling contains at least one of the elements of thallium, cobalt, tin, palladium, ruthenium and silver.

6. A mercury-free metal halide high-pressure discharge lamp according to claim 5, wherein the lamp filling contains zinc bromide, iron iodide and thallium iodide.

7. A mercury-free metal halide high-pressure discharge lamp according to claim 6, wherein the lamp filling further contains zinc iodide.

8. A mercury-free metal halide high-pressure discharge lamp according to claim 1, wherein the at least one noble gas comprises at least one of xenon and argon.

9. A mercury-free metal halide high-pressure discharge lamp according to claim 1, wherein the lamp filling does not contain any sodium iodide.

10. A mercury-free metal halide high-pressure discharge lamp according to clam 1, wherein the following relationship applies to the ratio of molar density of the zinc D in μmol/cm³ and electric field strength E in V/cm between the electrodes: 0.01≦D/E≦0.18.

11. (canceled)

12. (canceled)

13. A mercury-free metal halide high-pressure discharge lamp according to clam 1, wherein the ratio of molar density of the zinc D in μmol/cm³ and electric field strength between the electrodes E in V/cm is: 0.025≦D/E≦0.165.

14. An apparatus for generating ultraviolet radiation comprising a voltage source and a mercury-free metal halide high-pressure discharge lamp having:
a transparent and gastight sealed discharge vessel and
two electrodes which protrude into the discharge vessel and are arranged in the discharge vessel opposite one another;
with the discharge vessel having a discharge space that is filled with a lamp filling which comprises:
at least one noble gas,
at least the elements of iron and zinc, as well as
at least one halide, with the halide comprising a bromide, and with the percentage of the bromide being at least 14 mole percent of the total halogen quantity and the following relationship applying to the ratio of molar density of zinc D in μmol/cm³ and electric field strength E in V/cm between the electrodes: 0.005≦D/E≦0.200.

15. A photochemical process comprising the step of performing one of lacquer curing, disinfecting and tanning using a mercury-free metal halide high-pressure discharge lamp having:
a transparent and gastight sealed discharge vessel and
two electrodes which protrude into the discharge vessel and are arranged in the discharge vessel opposite one another;
with the discharge vessel having a discharge space that is filled with a lamp filling which comprises:
at least one noble gas,
at least the elements of iron and zinc, as well as
at least one halide, with the halide comprising a bromide, and with the percentage of the bromide being at least 14 mole percent of the total halogen quantity and the following relationship applying to the ratio of molar density of zinc D in μmol/cm³ and electric field strength E in V/cm between the electrodes: 0.005≦D/E≦0.200.
